(19) United States
(12) Patent Application Publication
(10) Pub. No.: US 2009/0255411 A1
(43) Pub. Date: Oct. 15, 2009

(54) EXTERNAL HEATING TYPE REDUCED PRESSURE FRYER

(76) Inventor: Kazuo Takahashi, Tokyo (JP)

Correspondence Address: OBLON, SPIVAK, MCCLELLAND MAIER & NEUSTADT, L.L.P., 1940 DUKE STREET, ALEXANDRIA, VA, 22314, US

(21) Appl. No.: 12/176,458

(22) Filed: Jul. 21, 2008

(30) Foreign Application Priority Data
Apr. 15, 2008 (JP) 2008-105526

(51) Int. Cl. A47J 37/12; B01D 35/02

(52) U.S. Cl. 99/407; 99/403; 99/408; 210/167.28

(57) ABSTRACT

To provide an external heating type reduced pressure fryer capable of carrying out a cycle of heating and circulating an oil between a frying tank and a heating apparatus even when a frying treatment of a food is carried out in the frying tank, the external heating type reduced pressure fryer includes a frying tank for immersing the food to a heated oil to be subjected to a frying treatment, an oil heating apparatus for heating the oil, an oil transferring path and an oil recirculating path connecting the frying tank and the oil heating apparatus, a circulating pump installed in the oil transferring path, and an oil/water separating portion for removing water in the oil, the oil/water separating portion includes a first baffle plate for forming a flow path of detouring the oil bent in an up and down direction, the water in the oil is interrupted by the baffle plate during a time period of making the oil flow to a downstream side while detouring the first baffle plate to promote the water to evaporate to a gas phase portion by boiling.

### FIELD OF THE INVENTION

The present invention relates to a fryer for immersing foods comprising various vegetables, fruits, marine products constituted by a thin plate shape, a stick-like shape, a dice-like shape or the like in a heated oil at inside of a frying tank under reduced pressure to subject to a frying treatment, particularly, relates to a reduced pressure fryer of an external heating type provided with a heating apparatus for heating an oil separately from the frying tank.

### BACKGROUND ART

A reduced pressure fryer of an external heating type provided with a heating apparatus for heating an oil separately from a frying tank is publicly-known in a background art as disclosed in, for example, Patent Reference 1, Patent Reference 2 or the like. A reduced pressure fryer of this kind is constituted such that the frying tank and the heating apparatus are connected with each other by an oil transferring pipe and an oil recirculating pipe, a circulating pump is connected to the oil transferring pipe, and a cycle of heating and circulating an oil is carried out between the frying tank and the heating apparatus by way of the oil transferring pipe and the oil circulating pipe by the circulating pump.

According to the reduced pressure fryer of the background art, normally, during a time period of subjecting food to a frying treatment by the frying tank, the cycle of heating and circulating the oil is not carried out by stopping to drive the circulating pump, and when food is not subjected to the frying treatment by the frying tank, the cycle of heating and circulating the oil is carried out by driving the circulating pump. The reason is that at inside of the main tank, when the frying treatment is carried out, a large amount of water included in food or water adhered thereto is mixed in the oil, and therefore, when the water is sucked to the frying pump, there is a concern of bringing about a cavitation. After some time period after finishing the frying treatment, the water becomes boiled water by being heated by the oil at high temperatures and evaporated and when the heating and circulating cycle is made to carry out after evaporating the water, there is not the concern of bringing about the cavitation by the circulating pump.

However, according to the method of intermittently carrying out the heating and circulating circle as described above, during a time period of carrying out the cycle of heating and circulating the oil, the treatment of frying food is interrupted, and therefore, an operating efficiency is deteriorated, further, during the frying treatment, the oil the temperature of which is reduced cannot be heated, and therefore, a temperature control becomes unstable and it is difficult to provide a product of a constant quality.

Patent Reference 1: Japanese Unexamined Patent Application Publication No. 58-221915

Patent Reference 2: Japanese Unexamined Patent Application Publication No. 58-221916

### DISCLOSURE OF THE INVENTION

It is an object of the invention to provide an external heating type reduced pressure fryer capable of carrying out a cycle of heating and circulating an oil between a frying tank and a heating apparatus even when a frying treatment of a food is carried out in the frying tank.

In order to resolve the problem, there is provided an external heating type reduced pressure fryer comprising a frying tank for immersing a food in a heated oil to be subjected to a frying treatment, an oil heating apparatus installed at a location separately from a location of the frying tank for heating the oil, an oil transferring path for transferring the oil at inside of the frying tank to the oil heating tank, an oil recirculating path for recirculating the oil heated by the oil heating tank to the frying tank, a circulating pump installed at a middle of the oil transferring path for circulating the oil between the frying tank and the oil heating tank by way of the oil transferring path and the oil recirculating path, and an oil/water separating portion arranged along the oil transferring path reaching the circulating pump from the frying tank for removing water provided into the oil by the food. The oil/water separating portion is constituted such that the oil/water separating portion includes an oil phase portion and a gas phase portion and includes a first baffle plate forming a detouring path of the oil bent in an up and down direction, the water in the oil is interrupted by the first baffle plate during a time period of making the oil flow to a downstream side while detouring the first baffle plate, and the interrupted water is promoted to evaporate to the gas phase portion by being heated by the oil.

According to the invention, preferably, the first baffle plate is constituted to interrupt a water drop sinking into the oil and make the oil flow by detouring an upper edge thereof by arranging the first baffle plate such that a peripheral edge thereof excluding the upper edge interrupts a flow path and the upper edge occupies a position downward from an oil face.

Further, according to the invention, there may be constructed a constitution in which the oil/water separating portion includes a second baffle plate on a downstream side of the first baffle plate, and is constituted to evaporate boiling water into the gas phase portion by interrupting the boiling water in the oil detouring the upper edge of the first baffle plate and makes the oil flow by detouring a lower edge of the second baffle plate by installing the second baffle plate such that the lower edge occupies a position downward from the upper edge of the first baffle plate and an upper edge thereof occupies a position exposed above the oil face.

In this case, the first baffle plate is arranged at a position forward from an oil transferring port at an inner portion of the frying tank, and the oil transferring port is provided at a position downward from the upper edge of the first baffle plate.

Further, according to the invention, there may be constructed a constitution in which the oil/water separating portion includes a separating tank formed at an outer portion of the frying tank, a height of an oil face of the oil phase portion of the separating tank is the same as a height of an oil face of an oil phase portion in the frying tank, the gas phase portion in the separating tank and a gas phase portion in the frying tank are communicated to each other by a uniform pressure path, and the baffle plate is arranged in the separating tank.

According to the reduced pressure fryer of the invention, even when a large amount of water included in the food or water adhered thereto is mixed to the oil in the frying tank in subjecting the food to the frying treatment, the water is interrupted by the first baffle plate when the oil in the frying tank is transferred to the heating apparatus by detouring the first baffle plate installed at the oil/water separating portion to promote evaporation to the gas phase portion by boiling, and therefore, cavitation is not brought about by sucking steam to the circulating pump, as a result, even when the frying treatment of the food is carried out in the frying tank, a cycle of heating and circulating the oil can be carried out between the frying tank and the heating apparatus, the reduced pressure fryer is excellent in a driving efficiency and also a temperature control thereof is facilitated.

### BRIEF DESCRIPTION OF THE DRAWINGS

FIG. 1 is a constitution view schematically showing a first embodiment of an external heating type reduced pressure fryer according to the invention.

FIG. 2 is a sectional view taken along a line II-II of FIG. 1.

FIG. 3 is a sectional view showing only a separating tank of a second embodiment of the invention.

FIG. 4 is a sectional view showing a frying tank and a separating tank of a third embodiment of the invention.

FIG. 5 is a sectional view taken along a line V-V of FIG. 4.

FIG. 6 is a sectional view showing a frying tank and a separating tank of a fourth embodiment of the invention.

FIG. 7 is a sectional view taken along a line VII-VII of FIG. 6.

### DETAILED DESCRIPTION OF THE PREFERRED EMBODIMENTS

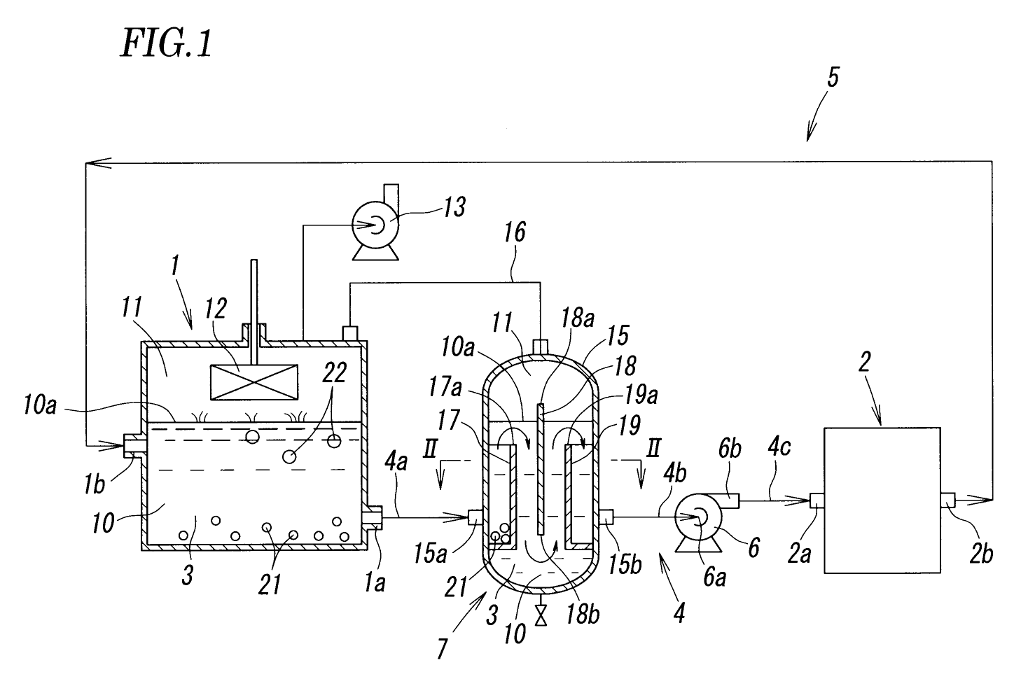

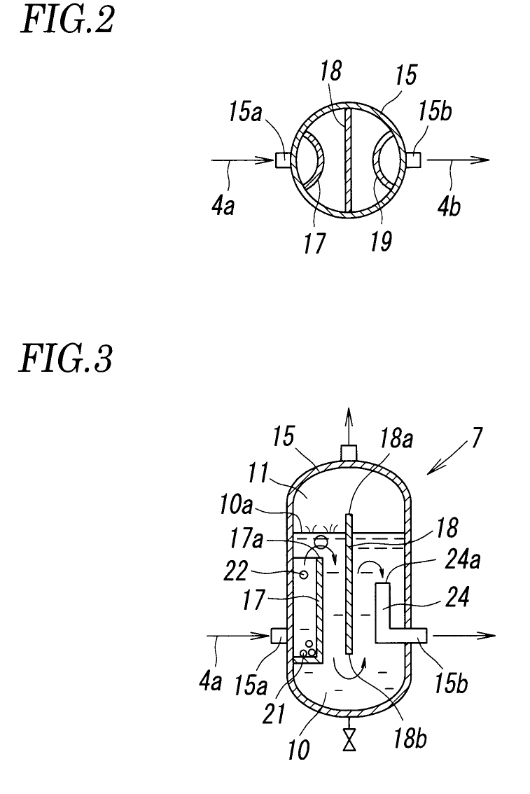

FIG. 1 and FIG. 2 show a first embodiment of an external heating type reduced pressure fryer according to the invention. The reduced pressure fryer includes a frying tank 1 for immersing food to a heated oil 3 to subject to a frying treatment, an oil heating apparatus 2 installed at a location separately from that of the frying tank 1 for heating the oil 3, an oil transferring path 4 for transferring the oil 3 at inside of the frying tank 1 to the oil heating apparatus 2 by way of an oil transferring port 1a, an oil recirculating path 5 for recirculating the oil 3 heated by the oil heating apparatus 2 to the frying tank 1 by way of an oil flowing port 1b, a circulating pump 6 installed at a middle of the oil transferring path 4 for circulating the oil 3 between the frying tank 1 and the oil heating apparatus 2 by way of the oil transferring path 4 and oil recirculating path 5, and an oil/water separating portion 7 arranged along the oil transferring path 4 reaching the circulating pump 6 from the frying tank 1 in order to remove water provided into the oil by the food.

The frying tank 1 is a rectangular vessel having pressure resistance and heat resistance, and inside of the frying tank 1 is formed with an oil phase portion 10 and a gas phase portion 11 by containing the oil 3 of about ½ through ⅔ of a volume of the frying tank 1. Further, at inside of the frying tank 1, a porous fool food case 12 is contained to be able to come in and go out and liftably by way of an opening portion, not illustrated, foods in a thin plate shape, a stick-like shape, a dice-like shape or the like comprising various kinds of vegetables, fruits, marine products are contained at inside of the food case 12, and the foods are subjected to a frying treatment by immersing the food case 12 into the oil 3 for a predetermined time period in a state of reducing a pressure at inside of the frying tank 1 by a vacuum pump 13.

The food is adhered with a large amount of water at a surface thereof by washing, the food per se includes a large amount of water, and therefore, when the frying treatment is carried out by carrying in the food into the frying tank 1 and immersing the food in the oil, the water adhered to the food is dropped into the oil 3, sinks to a vicinity of an oil bottom temporarily in a state of a water drop 21, thereafter, brought into a state of boiling water 22 by being heated by the oil 3 at high temperatures, gradually rises while being floated in the oil and is evaporated into the gas phase portion 11 under the reduced pressure from an oil face 10a. Further, the water contained in the food is discharged into the oil in a state of steam (boiling water), thereafter, rises while being floated in the oil and is evaporated from the oil face 10a.

Further, in the oil transferring port 1a and the oil flowing port 1b, the oil transferring port 1a is disposed at a bottom of the flying tank 1 or a low position proximate to the tank bottom, and the oil flowing port 1b is provided at a position proximate to the oil face 10a at a position higher than the oil transferring port 1a.

The oil/water separating portion 7 includes a separating tank 15 formed separately from the frying tank 1. The separating tank 15 is a vessel in a shape of a vertical cylinder having pressure resistance and heat resistance, and includes an oil inlet 15a and an oil outlet 15b disposed on a side of a tank bottom of a center position in an oil depth direction at positions opposed to each other proximate to a tank bottom side. Among them, the oil inlet 15a is connected to the oil transferring port 1a of the frying tank 1 by a pipe 4a, the oil outlet 15b is connected to a suction port 6a of the circulating pump 6 by a pipe 4b, and a delivery port 6b of the circulating pump 6 is connected to an oil inlet 2a of the heating apparatus 2 by a pipe 4c. The pipes 4a, 4b, 4c respectively form portions of the oil transferring path 4.

Inside of the separating tank 15 is formed with the oil phase portion 10 by the oil 3 transferred from the frying tank 1 to stay temporarily, and the gas phase portion 11, and a height of the oil face 10a is the same as a height of the oil face 10a of the oil phase portion 10 at inside of the frying tank 1. Further, the gas phase portion 11 at inside of the separating tank 15 is communicated with the gas phase portion 11 at inside of the frying tank 1 by a uniform pressure path 16 to be brought into a state of the same pressure and the reduced pressure.

Further, inside of the separating tank 15 is arranged with a plurality of baffle plates 17, 18, 19 forming a detouring flow path of the oil waved in an up and down direction. In the illustrated example, the three baffle plates are arranged and during a time period in which the oil 3 is made to flow while detouring the baffle plates 17, 18, 19, the water in the oil is interrupted to promote evaporation to the gas phase portion from the oil face 10a by boiling the water.

In the three baffle plates 17, 18, 19, the first baffle plate 17 disposed on the most upstream side is bent in an arc shape in a plane view thereof, at a position opposed to the oil inlet 15a, and a peripheral edges excluding the upper edge 17a, that is, left and right side edges and a lower edge are connected to the tank wall of the separating tank 15 to thereby interrupt the flow path and the upper edge 17a is installed to form a detouring flow path by occupying a position lower than the oil face 10a. However, the first baffle plate 17 may be constituted by a flat plate shape or may be constituted by other shape.

The second baffle plate 18 disposed on a downstream side of the first baffle plate 17 is constituted by a flat plate shape, interrupts the flow path by connecting two left and right side edges to the tank wall at a center portion of the separating tank 15, and a lower edge 18b forms a detouring flow path by occupying a position lower than the upper edge 17a of the upper edge 17a of the first baffle plate 17 and an upper edge 18a is installed to occupy a position disposed above the oil face 10a.

Further, the third baffle plate 19 disposed on a downstream side of the second baffle plate 18 is constituted by an arc shape similar to the first baffle plate 17, and the flow path is interrupted by connecting a peripheral edge excepts an upper edge 19a to the tank wall of the separating tank 15 at a position opposed to the oil outlet 15b, and the upper edge 19a is installed to form a detouring flow path by occupying a position lower than the oil face 10a. However, the third baffle plate 19 may be constituted by a flat plate shape or other shape.

By arranging the baffle plates, the oil 3 transferred into the separating tank 15 from the oil inlet 15a is made to flow upward along the first baffle plate 17, thereafter, flow downward between the first baffle plate 17 and the second baffle plate 18 by detouring the upper edge 17a of the first baffle plate 17, further, flow upward between the second baffle plate 18 and the third baffle plate 19 by detouring the lower edge 18b of the second baffle plate 18, thereafter, flow downward by detouring the upper edge 19a of the third baffle plate 19 and is transferred from the oil outlet 15b to the circulating pump 6.

Further, when water of the water drop 21 sinking near to oil bottom, the boiling water 22 or the like in an air bubble shape floating in the oil is transferred to inside of the separating tank 15 along with the oil 3 proceeding to inside of the separating tank 15 from the frying tank 1, the water drop 21 and the boiling water 22 are separated to remove from the inside of the oil by being interrupted by the baffle plates 17, 18, 19. That is, the heavy water drop 21 sinking into the oil is interrupted by the first baffle plate 17, and stays awhile at the position, however, the water brought into the state of the boiling water 22 already rises along with a rising flow of the oil 3 along the first baffle plate 17, thereafter, almost all of the water is evaporated into the gas phase portion 11 in the reduced pressure state from the oil face 10a by being interrupted by the second baffle plate 18. At this occasion, even when a portion of the boiling water 22 rides over the lower edge 18b of the second baffle plate 18 by riding over a falling flow of the oil 3, the boiling water 22 is evaporated into the gas phase portion 11 substantially completely during a time period in which the oil 3 rises between the second baffle plate 18 and the third baffle plate 19 at a next stage.

On the other hand, the water drop 21 interrupted by the first baffle plate 17 is heated by the oil 3 at high temperatures during a time period of staying awhile at the position to be brought into the state of the boiling water 22, thereafter, rises in the oil by riding over a rising flow of the oil 3, thereafter, evaporated into the gas phase portion 11 from the oil face 10a by being interrupted by the second baffle plate 18 and the third baffle plate 19.

Thereby, the content in the oil 3 is completely separated and removed and the oil 3 removing the water is transferred to the oil heating apparatus 2 by way of the circulating pump 6. Therefore, there is not a concern that the circulating pump 6 brings about a cavitation by sucking the steam.

The oil heating apparatus 2 pertinently includes heating means of a heat exchanger or the like using steam, electric heat or the like, and heats the oil 3 to a required tempered temperature by the heating means, and the oil 3 heated by the oil heating apparatus 2 is recirculated from the oil outlet 2b to the frying tank 1 by way of the oil recirculating path 5.

A cycle of heating and circulating the oil 3 between the frying tank 1 and the heating apparatus 2 can be carried out in parallel with the frying treatment even when the frying treatment of the food is carried out at the frying tank 1 by resolving the problem of the cavitation of the circulating pump 6. Therefore, the temperature of the oil 3 lowered by immersing food, mixing water can freely be increased to a required temperature in the frying treatment, a product of a constant and high quality can be provided by the stable temperature control, further, the operation efficiency is excellent since it is not necessary to interrupt the frying treatment. Naturally, the heating and circulating cycle can also be carried out in a state of interrupting the frying treatment.

FIG. 3 shows only the separating tank 15 constituting the oil/water separating portion 7 according to a second embodiment of the invention, and the second embodiment differs from the separating tank 15 of the first embodiment in that only two baffle plates of the first baffle plate 17 and the second baffle plate 18 are installed at an inner portion of the separating tank 15. That is, the inner portion of the separating tank 15, the first baffle plate 17 and the second baffle plate 18 are provided by a mode the same as that of the first baffle plate 17 and the second baffle plate 18 of the oil/water separating portion 7 of the first embodiment. Further, a guide out pipe 24 continuous to the oil outlet 15b is extended upwardly at inside of the oil phase portion 10 and a front end 24a of the guide out pipe 24 is opened into the oil phase portion 10 at a position higher than the lower edge 18b of the second baffle plate 18.

Even when according to the second embodiment, a portion of the boiling water 22 exceeds the lower edge 18b of the second baffle plate 18 by riding on a flow of the oil 3, the boiling water 22 floats up at inside of the oil during a time period in which the oil 3 rises in a region in which the guide out pipe 24 is interposed on a downstream side of the second baffle plate 18 and is evaporated into the gas phase portion 11 substantially completely and is not brought into the guide out pipe 24 from a front end thereof.

Other constitution and operation of the second embodiment are substantially the same as those of first embodiment, and therefore, illustration and explanation of a total constitution thereof will be omitted.

Further, according to the first embodiment and the second embodiment, when the first baffle plate 17 is provided in the plurality of baffle plates, the water drop 21 sinking into the oil which is the most problematic can be interrupted to promote evaporation thereof, and therefore, even when the other baffle plates 18 and 19 are omitted, a sufficient effect of promoting evaporation of water can be provided.

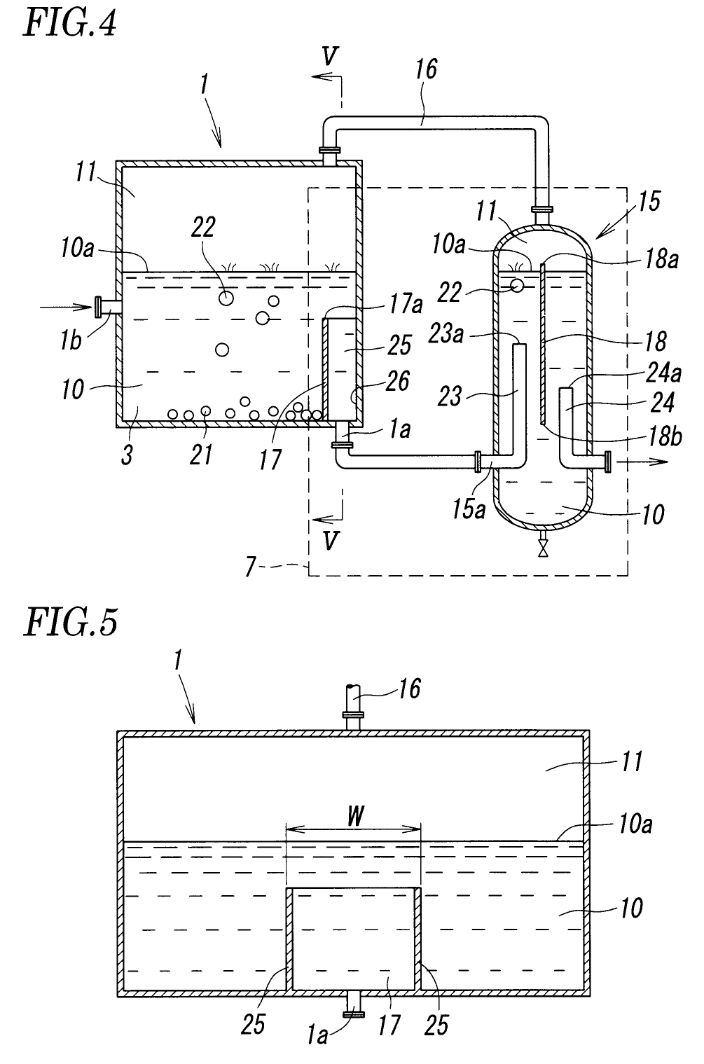

FIG. 4 and FIG. 5 shows the frying tank 1 and the separating tank 15 according to a third embodiment of the invention, and according to the third embodiment, the oil/water separating portion 7 is formed by a portion of the frying tank 1 and the separating tank 15. That is, the first baffle plate 17 is arranged at the inner portion of the frying tank 1 and the second baffle plate 18 is arranged at an inner portion of the separating tank 15. Among them, the first baffle plate 17 is installed at a position frontward from the oil transferring port 1a provided at a tank bottom of the frying tank 1 such that a peripheral edge excluding the upper edge 17a, that is, left and right side edges and a lower edge thereof are connected to the tank wall of the frying tank 1 to interrupt a flow path of the oil, the upper edge 17a occupies a position downward from the oil face 10a to form a detouring flow path, and the oil 3 is made to flow by detouring the upper edge 17a.

The first baffle plate 17 is constituted by a flat plate a lateral width W of which is smaller than a lateral width of the frying tank 1, and the left and right side edges of the first baffle plate 17 are connected to a side wall 1c of the frying tank 1 by a connecting wall 25 extended orthogonally from the side edge. Thereby, an oil transferring portion 26 constituted by a shape of a small box an upper face of which is opened for transferring the oil 3 to the oil transferring port 1a between the first baffle plate 17 and the side wall 1c of the frying tank 1.

However, the lateral width W of the first baffle plate 17 may be formed by a size the same as the lateral width of the frying tank 1 and both side end portions of the first baffle plate 17 may be connected to the left and right tank walls of the frying tank 1.

On the other hand, the second baffle plate 18 is constituted by a shape of a flat plate and is installed at inside of the separating tank 15 such that a flow path is interrupted by connecting both left and right side edges of the tank wall, the lower edge 18b occupies a position downward from the upper edge 17a of the first baffle plate 17 to form a detouring path, further, the upper edge 18a occupies a position exposed above the oil face 10a. Further, at inside of the separating tank 15, a guide in pipe 23 communicated with the oil inlet 15a and the guide out pipe 24 communicated with the oil outlet 15b are extended upward at inside of the oil phase portion 10 and front ends 23a and 24a are respectively opened in the oil phase portion 10 at the positions higher than the lower edge 18b of the second baffle plate 18.

Further, although in the illustrated example, heights of the front ends 23a and 24a of the guide in pipe 23 and the guide out pipe 24 differ from each other, the heights may be the same.

According to the third embodiment, in water provided into the oil by food in carrying out the frying treatment of the food, the water drop 21 sinking near to the oil bottom is interrupted by the first baffle plate 17 and is hampered from flowing into the oil transferring portion 26, stays awhile at the position, heated by the oil 3 at high temperatures to be brought into a state of the boiling water 22, rises in the oil and is evaporated into the gas phase portion 11 from the oil face 10a. Further, also the boiling water 22 discharged from the food rises in the oil and is evaporated into the gas phase portion 11 from the oil face 10a.

Even when a portion of water assumedly detours the upper edge 17a of the first baffle plate 17 along with the oil 3, flows to the oil transferring portion 26 and is transferred from the oil transferring port 1a to the separating tank 15, the water is evaporated at inside of the separating tank 15 by being interrupted by the second baffle plate 18 at inside of the separating tank 15, and separated and removed from the oil.

Further, constitution and operation of the third embodiment other than the above-described are substantially the same as those of the first embodiment, and therefore, illustration and explanation of the total constitution will be omitted.

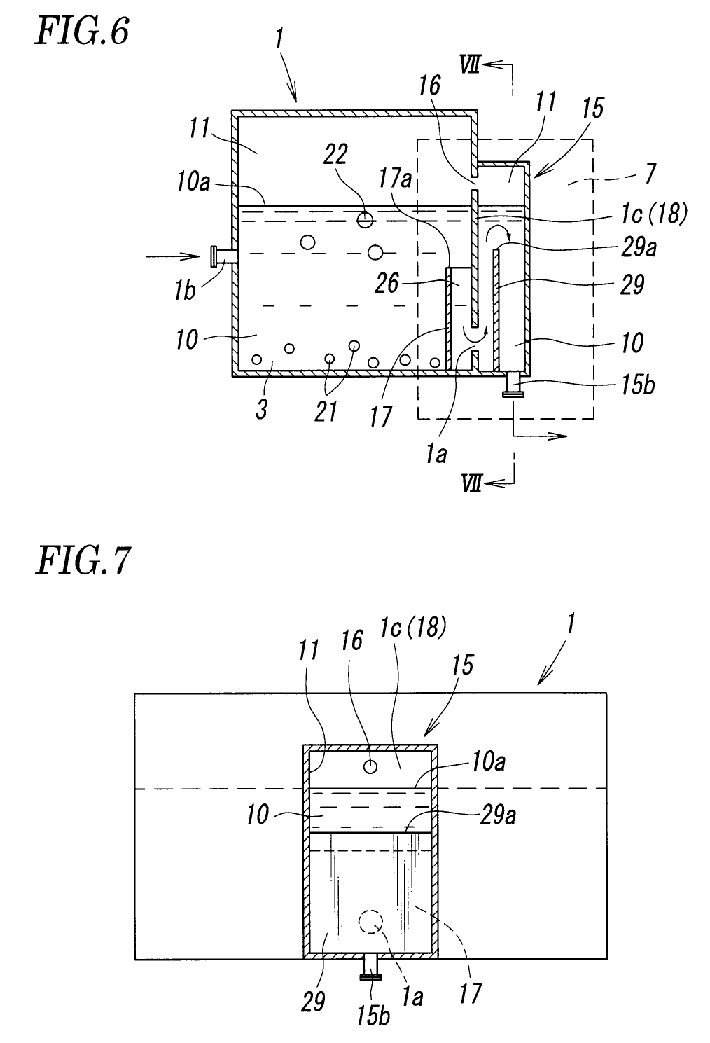

FIG. 6 and FIG. 7 show the frying tank 1 and the separating tank 15 according to a fourth embodiment of the invention and an essential point by which the fourth embodiment differs from the third embodiment resides in that the separating tank 15 is provided at an outer face of the frying tank 1 in a state of being continuous directly thereto. In this case, although the separating tank 15 may be constituted completely separately from the frying tank 1 and may be attached to the tank wall 1c of the frying tank 1 by being brought into close contact therewith, as illustrated, it is preferable to form the frying tank 1 and the separating tank 15 as an integral structure by making a portion of the tank wall 1c of the frying tank 1 serve also as a portion of a tank wall of the separating tank 15.

The oil phase portion 10 of the frying tank 1 and the oil phase portion 10 of the separating tank 15 are communicated with each other by way of the oil transferring port 1a formed at a low position near to the tank bottom of the tank wall 1c of the frying tank 1, further, the gas phase portion 11 of the frying tank 1 and the gas phase portion 11 of the separating tank 15 are communicated with each other by way of the uniform pressure path 16 formed at the tank wall 1c.

At the inner portion of the separating tank 15, one baffle plate 29 is installed at a position near to the oil outlet 15b such that the flow path of the oil is interrupted by connecting a peripheral edge excluding an upper edge 29a to the tank wall of the separating tank 15, and the upper edge 29a occupies a position downward from the oil face 10a to form a detouring flow path.

According to the fourth embodiment, the oil 3 at inside of the frying tank 1 detours the upper edge 17a of the first baffle plate 17 and falls at inside of the oil transferring portion 26, is transferred to the separating tank 15 from the oil transferring port 1a, thereafter, rises at inside of the separating tank 15 along the baffle plate 29, detours the upper edge 29a of the baffle plate 29, falls again and is transferred from the oil outlet 15b to the circulating pump 6.

At this occasion, similar to the case of the third embodiment, at inside of the frying tank 1, the water drop 21 sinking to the oil bottom is interrupted by the first baffle plate 17 and is heated by the oil 3 at high temperatures to be brought into the state of the boiling water 22 during a time period of staying awhile at the position, rises in the oil and is evaporated from the oil face 10a into the gas phase portion 11. Further, also the boiling water 22 discharged from the food rises in the oil and is evaporated from the oil face 10a into the gas phase portion 11.

Even when assumedly, a portion of water is transferred to the separating tank 15 by way of the oil transferring port 1a along with the oil 3, the water is evaporated and removed from the oil by being evaporated at inside of the separating tank 15 by being interrupted by the baffle plate 29 at inside of the separating tank 15.

According to the fourth embodiment, the above-described flow of the oil 3 generated by the first baffle plate 17, the oil transferring port 1a of the tank wall 1c of the frying tank 1, and the baffle plate 29 at inside of the separating tank 15 is substantially the same as the flow of the oil generated by the three first, second, third baffle plates 17, 18, 19 according to the first embodiment. This is because the tank wall 1c of the frying tank 1 having the oil transferring port 1a serves similar to the second baffle plate 18, and the baffle plate 29 at inside of the separating tank 15 serves similar to the third baffle plate 19, and therefore, the tank wall 1c can be regarded to serve as the second baffle plate and the baffle plate 29 can be regarded to serve as the third baffle plate.

Constitution and operation of the fourth embodiment other than the above-described are substantially the same as those of the first embodiment, and therefore, illustration and explanation of the total constitution will be omitted.

Further, also according to the third embodiment and the fourth embodiment, similar to the first embodiment and the second embodiment, when the first baffle plate 17 is provided, the other baffle plates 18 and 29 can be omitted. In this case, a portion of the frying tank 1, that is, a portion thereof installed with the first baffle plate 17 serves also as the separating tank, and therefore, the separating tank 15 can be omitted.

Further, in the respective embodiments, the frying tank 1 may be constituted by a shape of a circular cylinder, and the separating tank 15 may be constituted by a rectangular shape.

1. As external heating type reduced pressure fryer comprising a frying tank for immersing a food in a heated oil to be subjected to a frying treatment, an oil heating apparatus installed at a location separately from a location of the frying tank for heating the oil, an oil transferring path for transferring the oil at inside of the frying tank to the oil heating tank, an oil recirculating path for recirculating the oil heated by the oil heating tank to the frying tank, a circulating pump installed at a middle of the oil transferring path for circulating the oil between the frying tank and the oil heating tank by way of the oil transferring path and the oil recirculating path, and an oil/water separating portion arranged along the oil transferring path reaching the circulating pump from the frying tank for removing water provided into the oil by the food;
wherein the oil/water separating portion is constituted such that the oil/water separating portion includes an oil phase portion and a gas phase portion and includes a first baffle plate forming a detouring path of the oil bent in an up and down direction, the water in the oil is interrupted by the first baffle plate during a time period of making the oil flow to a downstream side while detouring the first baffle plate, and the interrupted water is promoted to evaporate to the gas phase portion by being heated by the oil.

2. The external heating type reduced pressure fryer according to claim 1, the first baffle plate is constituted to interrupt a water drop sinking into the oil and make the oil flow by detouring an upper edge thereof by arranging the first baffle plate such that a peripheral edge thereof excluding the upper edge interrupts a flow path and the upper edge occupies a position downward from an oil face.

3. The external heating type reduced pressure fryer according to claim 2, wherein the oil/water separating portion includes a second baffle plate on a downstream side of the first baffle plate, and is constituted to evaporate boiling water into the gas phase portion by interrupting the boiling water in the oil detouring the upper edge of the first baffle plate and makes the oil flow by detouring a lower edge of the second baffle plate by installing the second baffle plate such that the lower edge occupies a position downward from the upper edge of the first baffle plate and an upper edge thereof occupies a position exposed above the oil face.

4. The external heating type reduced pressure fryer according to claim 2 or 3, wherein the first baffle plate is arranged at a position forward from an oil transferring port at an inner portion of the frying tank, and the oil transferring port is provided at a position downward from the upper edge of the first baffle plate.

5. The external heating type reduced pressure fryer according to any one of claims 1 through 3, wherein the oil/water separating portion includes a separating tank formed at an outer portion of the frying tank, a height of an oil face of the oil phase portion of the separating tank is the same as a height of an oil face of an oil phase portion in the frying tank, the gas phase portion in the separating tank and a gas phase portion in the frying tank are communicated to each other by a uniform pressure path, and the baffle plate is arranged in the separating tank.

6. The external heating type reduced pressure fryer according to claim 4, wherein the oil/water separating portion includes a separating tank formed at an outer portion of the frying tank, a height of an oil face of the gas phase portion of the separating tank is the same as a height of an oil face of an oil phase portion in the frying tank, the gas phase portion in the separating tank and a gas phase portion in the frying tank are communicated to each other by a uniform pressure path, and the second baffle plate is arranged in the separating tank.
